(19) United States
(12) Patent Application Publication
(10) Pub. No.: US 2007/0091127 A1
(43) Pub. Date: Apr. 26, 2007

(54) Arrangement with a panel of a flat screen

(75) Inventor: Ralf Edelbrock, Karlsruhe (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, Munchen (DE)

(21) Appl. No.: 10/574,678

(22) PCT Filed: Oct. 8, 2004
(86) PCT No.: PCT/EP04/11299

§ 371 Date: Apr. 4, 2006

(30) Foreign Application Priority Data
Oct. 9, 2003 (DE) 103 47 036.0

(51) Int. Cl. G09G 5/10

(52) U.S. Cl. 345/690

(57) ABSTRACT

The invention relates to an arrangement with a panel of a flat display and with a graphics processor to which a digitized image signal can be supplied by an A/D converter, said image signal being generated from an analog image signal by the A/D converter. An amplification of the A/D converter can be set in such a manner that the A/D converter generates a maximum video step of the digital image signal from the highest video level of the analog image signal. Appropriate measures are used to reduce interfering influences upon the contrast of an image due to aging effects of the transparent portions of the panel, e.g. due to aging effects of the panel glass, the LCD liquid or of the diffuser films and/or polarization films, and permit the sensor to be seen via the display surface only during a calibrating phase. The contrast is automatically adjusted on site, e.g. when the flat display is used in the medical field, thereby eliminating the need for service personnel.

### CROSS REFERENCE TO RELATED APPLICATIONS

This application claims priority to the German application No. 10347036.0, filed Oct. 9, 2003, and to the International Application No. PCT/EP2004/011299, filed Oct. 8, 2004 which are incorporated by reference herein in their entirety.

### FIELD OF INVENTION

The invention relates to an arrangement with a panel of a flat screen, with a graphics processor, to which a digitized image signal can be supplied by an A/D converter, said image signal being generated from an analog image signal by the A/D converter. The amplification of the A/D converter can be set such that the A/D converter generates a maximum video step of the digital image signal from the highest video level of the analog image signal.

### BACKGROUND OF INVENTION

Generally the contrast of a panel is factory set such that a maximum video step is generated from the highest video level, e.g. a video level of 0.7 volts, of an analog image signal, when a white image is displayed on the panel. If an 8-bit A/D converter is provided for example, the amplification is set such that said A/D converter generates a video step 255 from the highest video level of 0.7 volts. Too low a contrast level produces an image with poor contrast and gray scales are lost, as the A/D converter does not generate the maximum possible video step from a maximum video level. Too high a contrast level however means that the A/D converter outputs the maximum video step before the maximum video level is reached, causing image information to be lost.

### SUMMARY OF INVENTION

An object of the present invention is to specify an arrangement of the type mentioned above, with which contrast adjustment is simplified during a calibration phase.

This object is achieved by the claims.

It is advantageous for influences that interfere with the contrast of an image due to ageing effects of the transparent parts of the panel, e.g. due to ageing effects of the panel glass, the LCD liquid or the diffuser films and/or polarization films, to be reduced and for it only to be possible to see the sensor via the display surface during a calibration phase. The contrast is adjusted automatically on site, e.g. when the flat screen is in use in the medical field, so there is no need for service personnel.

In one embodiment of the invention the sensor can be lowered in the direction of the panel, thereby reducing the distance between the sensor and panel, producing better measuring results.

The measuring results are also improved by providing sealing means to screen the sensor from ambient light. These sealing means, e.g. in the form of sealing lips, prevent the ambient light having an adverse effect on the measuring results.

In a further embodiment of the invention according to the measures specified in claim 4 the sensor is cleaned automatically. This largely prevents contamination of the sensor, which has an adverse effect on the measuring results, and it is also possible to increase the time intervals between sensor maintenance operations.

The sensor and the means for swiveling the sensor out are advantageously disposed in a recess in the frame, preferably the lateral frame of the flat screen, with the result that during normal operation, i.e. outside the calibration phases, the sensor and swiveling means cannot be seen by an observer.

### BRIEF DESCRIPTION OF THE DRAWINGS

The invention, its embodiments and advantages are described in more detail below with reference to the drawing, which illustrates an exemplary embodiment of the invention, in which:

FIG. 1 shows an arrangement for setting the contrast of an image that can be displayed on an LCD panel,

FIG. 2 shows a diagram of the dependency of digitized voltage values on analog video voltages and

FIGS. 3 and 4 show a sensor disposed on a sensor support viewed from the front and side and from above.

### DETAILED DESCRIPTION OF INVENTION

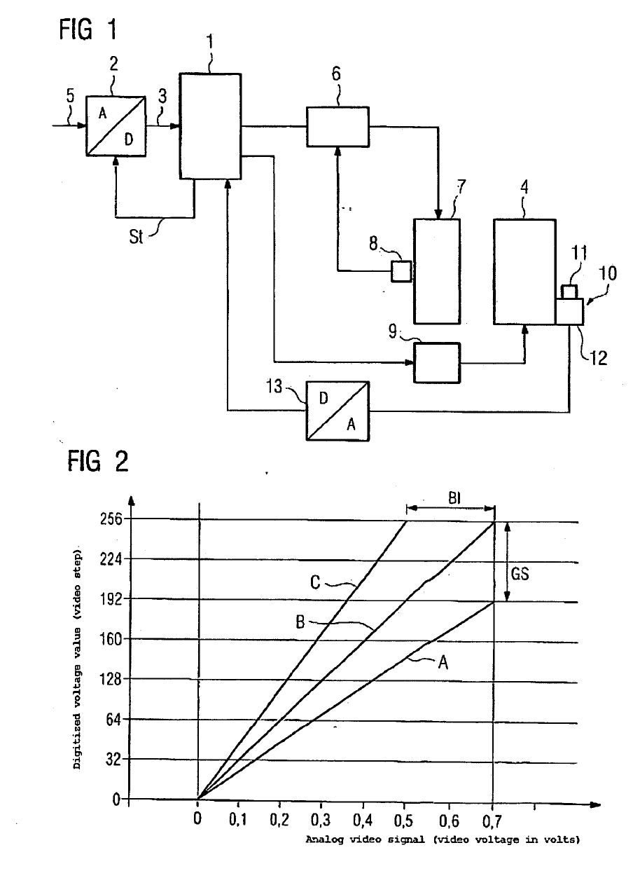

In FIG. 1 the reference character 1 indicates a graphics processor, to which a digitized image signal 3 can be supplied by an 8-bit A/D converter 2 to display an image on an LCD panel 4 of a flat screen. It is assumed that the digitized image signal 3 comprises video steps from 0 to 255, which the A/D converter 2 generates from an analog image signal 5 in a voltage range of 0 volts to 0.7 volts. The graphics processor 1 controls a backlight regulator 6, which adjusts the luminance of a backlight 7, to achieve essentially constant luminance conditions. To this end a backlight sensor 8 is provided, which captures the luminance of the backlight 7, which sets the backlight regulator 6 to a target luminance. The graphics processor 1 transmits the digital image signal to the panel 4 via a suitable interface 9, as a result of which the image information is displayed visually.

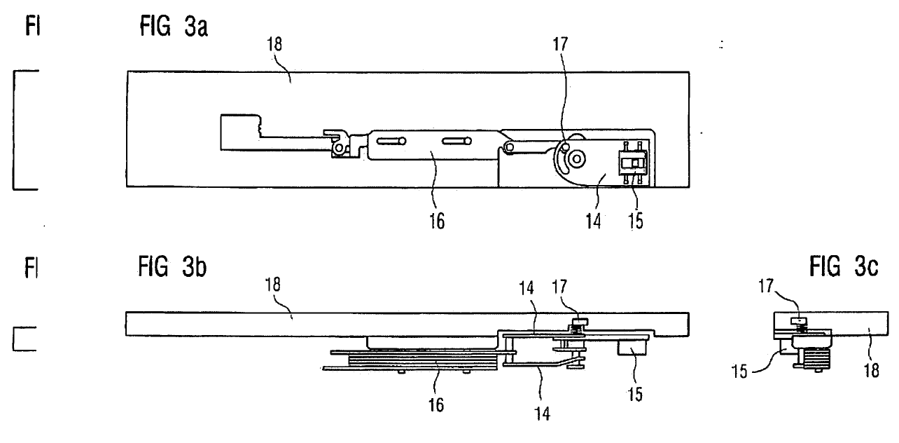

Reference is made below to FIG. 2, in which the dependency of digitized voltage values (video steps) at the output of an 8-bit A/D converter on video voltages (analog video signal) at its input is shown. A first instance (straight line A) shows too low a contrast setting, as the A/D converter only generates a video step 192 at its output from a maximum video input voltage of 0.7 volts. This means that gray scales GS are lost compared with a correct contrast setting (straight line B). In a second instance (straight line C) the contrast setting is too high, causing the A/D converter to generate a maximum video step 255 at the output from a video voltage of as little as 0.5 volts at the input. This means that image information BI is lost compared with the correct contrast setting (straight line B).

To prevent the contrast level being too low or too high, the amplification of the 8-bit A/D converter should be set such that it generates the maximum video step 255 from the maximum video voltage of 0.7 volts when a white image is being displayed.

In order to set the amplification of the A/D converter 2 (FIG. 1) automatically in a corresponding manner, during a calibration phase the graphics processor 1 reduces the amplification of the A/D converter 2 gradually from a maximum, while at the same time a measuring unit 10 on the front face of the panel 4 scans the optical image information of a white image displayed on the panel and captures the luminance of this white image. The measuring unit 10 transmits the captured luminance to the graphics processor 1 via an A/D converter 13. If the graphics processor 1 identifies a first change in the luminance, it sets the amplification of the A/D converter 2 one step higher via a control line St, thereby terminating the amplification setting operation and therefore the contrast adjustment.

The white image does not have to fill the panel completely. It is sufficient to display the white image in a “calibration window”, with the option of overlaying said white image in said window, even while an image is being displayed during a normal operating phase of the flat screen.

Components of the measuring unit 10 include a sensor 11 and a sensor support 12, on which the sensor 11 is mounted. The sensor 11 and the sensor support 12 are disposed in a recess in the frame of the flat screen such that they cannot be seen by an observer. In order to be able to capture the luminance of the white image during the calibration phase, the sensor 11 can be swiveled out essentially parallel to the panel from a rest position into a capture position, in which the sensor 11 is positioned such that it can be seen by the observer. The sensor 11 is preferably lowered in the direction of the panel 4 during the swiveling out operation, such that the sensor 11 can capture the luminance efficiently, without touching the panel 4. After the calibration phase the sensor 11 is swiveled back into the rest position, in which the sensor 11 and the sensor support 12 are positioned in the recess in the flat screen frame, such that they cannot be seen by the observer once again.

So that ambient light does not interfere with the capturing of the luminance, sealing lips (not shown here) are provided, which screen the sensor 11 from the ambient light.

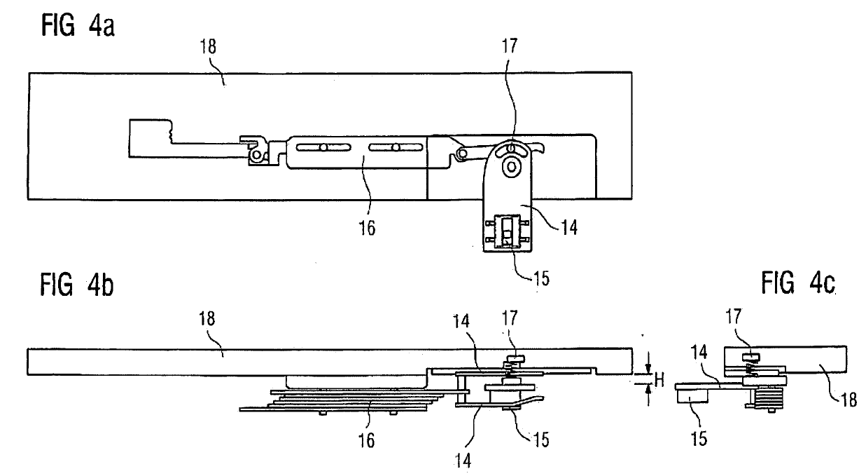

Reference is made below to FIGS. 3 and 4, in which a sensor 15 disposed on a sensor support 14 is shown viewed from the front (FIGS. 3a, 4a), the side (FIGS. 3b, 4b) and from above (FIGS. 3c, 4c). The sensor support 14 is supported in a rotatable manner and can be swiveled out by an actuator 16 and mechanical means 17. The actuator 16, e.g. an actuator by the company Nanomuscle, internet address: http.nanomuscle.com, is disposed together with the sensor support 14 and the sensor 15 in a recess in a frame of a flat screen, preferably on a vertical part of the frame, and is mounted on a support plate 18 covered by the frame and disposed parallel to the frame. As a result the support plate 18, the mechanical means 17, the actuator 16, the sensor 15 and the sensor support 14 cannot be seen by an observer of the panel in a rest position (FIG. 4). In a capture position during a calibration phase (FIG. 4), in which the sensor 15 captures the luminance of a panel, the sensor support 14 with the sensor 15 is swiveled out to an angle of 90 degrees, with the sensor support 14 being lowered in the direction of the panel surface (shown by lowering height H in FIGS. 4b, 4c) at the same time as the swiveling out operation, to position the sensor 15 nearer to the panel surface. Sealing lips (not shown here) prevent ambient light falsifying the measuring results. Once the sensor 15 is positioned, the luminance of the test image displayed on the panel in a calibration window is captured for the period of the calibration phase, with the calibration window being able to be overlaid in the normal image. The sensor 14 is swiveled into its rest position after the calibration phase.

1.-5. (canceled)

6. A flat screen panel arrangement, comprising:
a flat screen comprising a flat screen panel;
an A/D converter for generating a digital image signal from an analog image signal, the A/D converter having an adjustable amplification for generating a maximum video step of the digital image signal based on a maximum video level of the analog image signal;
a graphics processor configured to receive the digital image signal;
a sensor having a hidden arrangement at the flat screen such that a user of the flat screen does not visually notice the sensor, the sensor sized, arranged and configured to acquire a luminance of a white image displayed on the flat screen panel during a calibration procedure; and
a swiveling mechanism for swiveling the sensor from a stand-by position into an acquisition position, the sensor swiveled into the acquisition position when acquiring the luminance, wherein the swiveling of the sensor includes a swiveling movement essentially parallel to the flat screen panel, wherein the graphics processor is configured to:
effect change of the luminance by adjusting the amplification of the A/D converter;
evaluate the change of luminance; and
reach a final adjustment setting of the amplification based on the evaluated change of luminance.

7. The flat screen panel arrangement according to claim 6, wherein the swiveling movement includes lowering the sensor towards the flat screen panel.

8. The flat screen panel arrangement according to claim 6, further comprising a sealing device for screening the sensor from ambient light while acquiring the luminance.

9. The flat screen panel arrangement according to claim 6, further comprising a cleaning device for cleaning the sensor before, during or after the swiveling movement.

10. The flat screen panel arrangement according to claim 6, further comprising a frame for accommodating the flat screen, wherein the sensor and the swiveling mechanism are arranged in a recess of the frame.
